(19) United States
(12) Patent Application Publication
(10) Pub. No.: US 2009/0062954 A1
(43) Pub. Date: Mar. 5, 2009

(54) METHOD AND SYSTEM FOR AUTO-DISPATCHING LOTS IN PHOTOLITHOGRAPHY PROCESS

(75) Inventors: Yung-Yao Lee, Tainan County (TW); Cheng-Fa Lin, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PROMOS TECHNOLOGIES INC., Hsinchu (TW)

(21) Appl. No.: 12/115,555

(22) Filed: May 6, 2008

(30) Foreign Application Priority Data
Aug. 29, 2007 (TW) 96132011

(51) Int. Cl. G06F 17/00

(52) U.S. Cl. 700/121

(57) ABSTRACT

A method and a system for auto-dispatching lots in a photolithography process are provided. According to the method, first, a prioritized lot list is established according to the working status of a plurality of photolithography equipments. Then, a processable lot with the highest priority from the lot list is selected and a relative process background information is used for determining a photolithography operation type. Finally, the selected lot is dispatched according to the photolithography operation type. The present invention dispatches the lot with the appropriate dispatching rule according to the process background information of the lot. As a result, the quality of the photolithography process can be ensured so as to increase the throughput, and the labor overhead can be reduced to achieve the purpose of production cost reduction.

### CROSS-REFERENCE TO RELATED APPLICATION

This application claims the priority benefit of Taiwan application serial no. 96132011, filed on Aug. 29, 2007. The entirety of the above-mentioned patent application is hereby incorporated by reference herein and made a part of this specification.

### BACKGROUND OF THE INVENTION

1. Field of the Invention

The present invention generally relates to a method and a system for auto-dispatching lots, in particularly, to a method and a system for auto-dispatching lots in a photolithography process.

2. Description of Related Art

Semiconductor manufacturing is an extremely complex technology, and involves hundreds of processes to complete the wafer fabrication. A photolithography process, which further includes various procedures such as photoresist coating, baking, reticle alignment, exposing, and developing etc, is one of the most critical processes. Generally speaking, the process for dispatching lots in the photolithography process is very complicated, and accordingly, the photolithography process is less automated than the other processes in the semiconductor manufacturing.

In a semiconductor manufactory, the lot dispatching system is completely independent from the photolithography processing system. In other words, to dispatch some lots, an engineer has to inform an operator of which lots are to be dispatched and the processing modes of these lots. The operator then dispatches the lots manually according to the instruction of the engineer and moves the front opening unified pod (FOUP) loaded with chips to a photolithography equipment. However, the engineer may only know which processing mode can ensure the best lot quality but not know the processing schedule of each of the photolithography equipments in the plant. In other words, the engineer does not know which type of lots is most suitable to be processed by the currently available photolithography equipment.

As described above, even though the operator dispatches lots to the photolithography equipment according to the instruction of the engineer, the photolithography equipment may not be ready for performing the corresponding operation and accordingly the operator has to move the dispatched lots from this photolithography equipment to another photolithography equipment. Thereby, the processing time is wasted and accordingly the system throughput is reduced. Meanwhile, the operator has to stay on site to monitor the process and to prevent any unexpected situation, which increases the labor overhead and accordingly the production cost.

### SUMMARY OF THE INVENTION

Accordingly, the present invention is directed to a method for auto-dispatching lots in a photolithography process, wherein processable lots are dispatched according to the working status of photolithography equipments, so that the system throughput is increased.

The present invention is directed to a system for auto-dispatching lots in a photolithography process, wherein an appropriate dispatching way and a corresponding photolithography operation are determined according to a process background information of the lot, so that the automatization of the photolithography process is increased and accordingly the labor overhead is reduced.

The present invention provides a method for auto-dispatching lots in a photolithography process. The method is suitable for a semiconductor manufactory having a plurality of photolithography equipments. The method includes following steps. First, a lot list is established according to the working status of each of the photolithography equipments, wherein the lot list contains a plurality of prioritized processable lots. Next, the processable lot having the highest priority is selected from the lot list, and an appropriate dispatching way is determined according to a process background information of the selected lot so as to process the corresponding photolithography operation. After that, the corresponding photolithography operation is performed to the processable lot according to the photolithography operation type.

The present invention further provides a system for auto-dispatching lots in a photolithography process. The system includes a lot list establishing system, a type determination module, and a photolithography processing system. The lot list establishing system establishes a lot list according to the working status of a plurality of photolithography equipments, wherein the lot list contains a plurality of processable lots. The type determination module connected to the lot list establishing system selects a processable lot from the lot list and determines a corresponding photolithography operation type according to a process background information of the processable lot. The photolithography processing system connected to the type determination module performs a photolithography operation to the processable lot according to the photolithography operation type.

The present invention requests the production line to dispatch the lot matches the status requirement according to the working status of photolithography equipments, and a corresponding photolithography operation type of the lot is determined according to the process background information of the lot, so that different photolithography operations can be performed accordingly. Thereby, the quality of the photolithography process is ensured and the throughput thereof is increased, and meanwhile, labour overhead is reduced and accordingly the production cost is also reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a system for auto-dispatching lots in a photolithography process according to an embodiment of the present invention.

FIG. 2 is a flowchart illustrating a method for auto-dispatching lots in a photolithography process according to an embodiment of the present invention.

FIG. 3 is a flowchart illustrating a method for establishing a lot list according to an embodiment of the present invention.

FIG. 4 is a partial tree structure diagram of a process background information according to an embodiment of the present invention.

FIG. 5 is a table of a classification rule corresponding to a process background information according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In a semiconductor manufactory, if a mechanism for auto-dispatching lots according to the working status of the photolithography equipment can be established between a production line and a photolithography processing system, not only the labour overhead for manually dispatching lots can be reduced, but the possibility of error occurrences can be decreased and accordingly the system throughput can be enhanced. Accordingly, the present invention provides a method and a system for auto-dispatching lots in a photolithography process. Embodiments of the present invention will be described below with reference to accompany drawings.

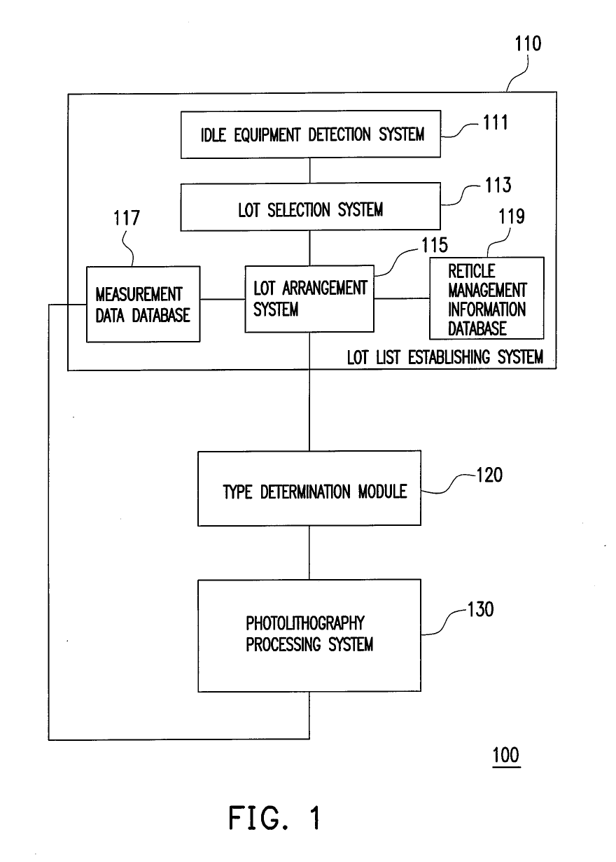

FIG. 1 is a block diagram of a system for auto-dispatching lots in a photolithography process according to an embodiment of the present invention. Referring to FIG. 1, in the present embodiment, the auto-dispatching system 100 is suitable for a semiconductor manufactory having a plurality of photolithography equipments. The auto-dispatching system 100 includes a lot list establishing system 110, a type determination module 120, and a photolithography processing system 130.

The lot list establishing system 110 establishes a lot list according to the working status of each of the photolithography equipments in the semiconductor manufactory. The lot list contains a plurality of processable lots. In the present embodiment, the lot list establishing system 110 further includes an idle equipment detection system 111, a lot selection system 113, a lot arrangement system 115, a measurement data database 117, and a reticle management information database 119. The lot list establishing system 110 selects processable lots and establishes the lot list through these sub-systems and databases.

The type determination module 120 connected to the lot list establishing system 110 selects one processable lot from the lot list and determines a corresponding photolithography operation type according to a process background information of the processable lot. In the present embodiment, the process background information contains at least the product title, the layer, the reticle used, the exposing equipment used, or the previous information of a non-photolithography process of the processable lot; however the content of the process background information is not restricted thereto.

The photolithography processing system 130 connected to the type determination module 120 performs different photolithography operation to the processable lot according to the photolithography operation type determined by the type determination module 120. In the present embodiment, the photolithography processing system 130 includes a plurality of sub-systems (not shown) which can perform different functions, and various photolithography operations are accomplished by different combinations of the sub-systems according to different photolithography operation types.

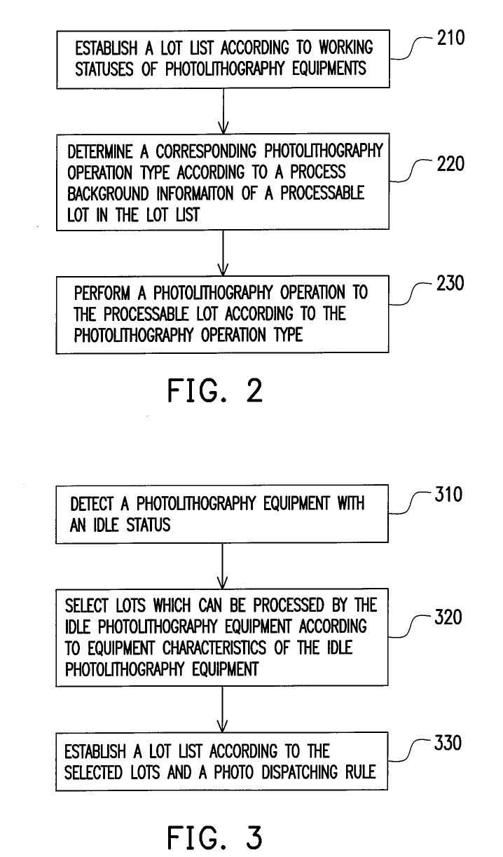

Below, another embodiment of the present invention will be described in order to explain the operation flow of the auto-dispatching system 100 clearly. FIG. 2 is a flowchart illustrating a method for auto-dispatching lots in a photolithography process according to an embodiment of the present invention. Referring to both FIG. 1 and FIG. 2, in step 210, the lot list establishing system 110 establishes a lot list according to the working statuses of various photolithography equipments in the semiconductor manufactory, wherein the lot list contains a plurality of processable lots.

FIG. 3 is a flowchart illustrating a method for establishing a lot list according to an embodiment of the present invention. Referring to FIG. 3, first, in step 310, the idle equipment detection system 111 in the lot list establishing system 110 detects the photolithography equipment with the idle status. In the present embodiment, the idle equipment detection system 111 may be a dispatching system or a dispatching software used by the semiconductor manufactory for determining which photolithography equipment is available for lot processing, and the scope of the idle equipment detection system 111 is not limited herein.

Next, in step 320, the lot selection system 113 selects those lots which can be processed by the idle photolithography equipment according to the equipment characteristics of the idle photolithography equipment. The lot selection system 113 comprising a manufacturing execution system (MES).

Finally, in step 330, the lot arrangement system 115 establishes the lot list according to the lots selected by the lot selection system 113 and a photo dispatching rule. Since there are many layers of products, the photo dispatching rule contains not only the priority of the product but also the layer information of lots which can be processed by each of the photolithography equipments. A lot waiting for processing is excluded from the lot list if the layer of the lot cannot be processed by the idle photolithography equipment.

It should be mentioned here that the measurement data database 117 in the lot list establishing system 110 records a measurement data generated in a previous photolithography operation performed to the lots, and the reticle management information database 119 records the mapping, between the photolithography equipments and the reticles (for example, whether a required reticle has been placed in the photolithography equipment etc). Accordingly, in an embodiment of the present invention, the lot arrangement system 115 determines which lots among the lots selected by the lot selection system 113 are processable lots according to the photo dispatching rule, the mapping between the photolithography equipments and the reticles, and the measurement data. And the lot arrangement system 115 also sorts all the processable lots to establish the lot list.

As described above, those lots which cannot be processed by the idle photolithography equipment are excluded from the lot list, so that the situation of knowing the equipment is unable to process the lots after the lot dispatching has been finished can be prevented, and accordingly the efficiency in lot dispatching can be improved.

After establishing the lot list, step 220 in FIG. 2 is executed, wherein the type determination module 120 is, for example, selecting one processable lot from the lot list in turn, and determining a corresponding photolithography operation type according to the process background information of the processable lot. In the present embodiment, the auto-dispatching system 100 further includes a classification rule database (not shown) for recording the classification rules corresponding to different process background information. The type determination module 120 determines the photolithography operation type of those processable lots having the same process background information according to the classification rule corresponding to the process background information of the processable lots.

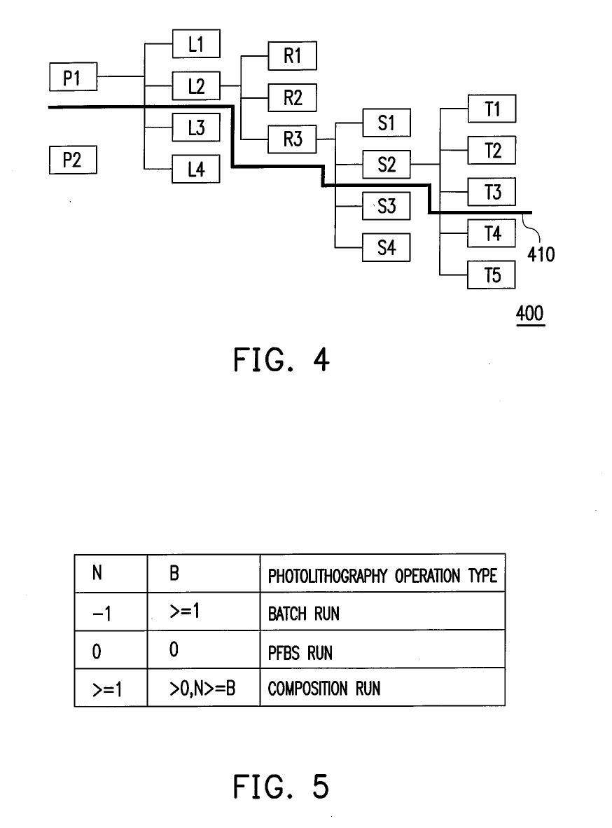

For example, assuming that the process background information contains the product title, the layer, the reticle used, the exposing equipment used, and the previous information of a non-photolithography process of a processable lot, the process background information can be illustrated with a tree structure diagram. Any lot has a path matching the process background thereof in the tree structure diagram during a photolithography operation. In the tree structure diagram 400 as shown in FIG. 4, all the lots adapted to the path 410 have the same process background information (i.e. having product title P1, layer L2, using reticle R3 and exposing equipment S2, and having the previous information of a non-photolithography process T3). An engineer can specify a classification rule for each process background information according to the experience thereof, the production generation, and the process conditions. The type determination module 120 determines the photolithography operation type of processable lots having the same process background information according to the corresponding classification rule.

There are many ways for processing lots in a photolithography process. In the present embodiment, the photolithography operation types can be categorized into a batch run, a photo feedback system (PFBS) run, and a composition run combining with the batch run and the PFBS run (the details of these three operation types will be respectively described below). Here it is assumed that the classification rule of a particular process background information contains two parameters B and N, wherein B and N are both integers. B represents the number of lots in each processing batch during the batch run. N represents the times of measurement data collection through batch run during the composition run when N is greater than 0. FIG. 5 illustrates a table of classification rule corresponding to a process background information according to an embodiment of the present invention. Referring to FIG. 5, each processable lot in a lot list has the corresponding parameters N and B. Thus, the type determination module 120 determines the photolithography operation type of those processable lots having the same process background information to be batch run, PFBS run, or composition run according to the classification rule illustrated in FIG. 5.

Next, referring to FIG. 2, in step 230, the photolithography processing system 130 performs a corresponding photolithography operation to the processable lot according to the photolithography operation type determined by the type determination module 120 and records a measurement data generated in the photolithography operation into the measurement data database 117. If the parameters N and B of the processable lot are respectively assumed to be −1 and 2 (which means the previous process or the photolithography equipment itself is not stable), the type determination module 120 determines that the corresponding photolithography operation type of the processable lot is the batch run according to the classification rule illustrated in FIG. 5, and the photolithography processing system 130 then performs the batch rum. To be specific, the photolithography processing system 130 first automatically combines two processable lots into a processing batch and then selects a testing chip from the processing batch to be tested in a photolithography operation and generates the measurement data. If the testing result meets a design specification, the photolithography processing system 130 performs a photolithography operation to the other lot in the processing batch according to the measurement data.

In another embodiment of the present invention, if the parameters N and B of the processable lot are respectively assumed to be 0 and 0 (which means the photolithography process and the photolithography equipment are both stable), the photolithography processing system 130 performs PFBS run according to the classification rule illustrated in FIG. 5. A PFBS run is a photolithography operation quickly performed to a processable lot according to a measurement data generated in a previous photolithography operation.

In yet another embodiment of the present invention, if the parameters N and B of the processable lot are respectively assumed to be 1 and 1 (which means a PFBS run cannot be performed directly because the existing measurement data is overdue, the photolithography equipment has been idle for too long, a new reticle has to be used, or the equipment breaks down and needs to be repaired etc), the photolithography processing system 130 first performs a batch run once according to the parameters N and B in order to collect a new measurement data, and after that, automatically converts to PFBS run so that the photolithography operation can be performed quickly and correctly. It should be mentioned here that the engineer can set the value of the parameter N based on the process consideration. For example, a smaller wafer size needs more precise photolithography operation. Consequently, more measurement data has to be collected first by performing the batch run several times, and then the PFBS run is quickly performed many times in order to ensure the quality of the lots.

In summary, the method and system for auto-dispatching lots in a photolithography process provided by the present invention have at least following advantages:

A corresponding photolithography operation type of a lot can be automatically determined according to a process background information of the lot, so that the labour for manually dispatching the lot is saved and accordingly the production cost is reduced.

A connection between a production line and a photolithography processing system is established, so that processable lots can be dispatched appropriately according to the states of the photolithography equipments, and accordingly the quality of the processable lots is ensured and the system throughput is increased.

The system can determine that how to efficiently and precisely dispatch different lots based on different conditions by maintaining a classification rule database, so that possible errors caused by manual dispatching can be prevented.

The automatization of the photolithography process is greatly increased so that the labour overhead is reduced and the possibility of error occurrences in lot processing is also reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for auto-dispatching lots in a photolithography process, suitable for a semiconductor manufactory having at least one photolithography equipment, comprising:
establishing a lot list according to working statuses of the photolithography equipments, wherein the lot list comprises at least one processable lot;
selecting one of the processable lots, and determining a corresponding photolithography operation type according to a process background information of the selected processable lot; and
performing a photolithography operation to the selected processable lot according to the photolithography operation type.

2. The method as claimed in claim 1, wherein the step of establishing the lot list comprises:
detecting the photolithography equipment with an idle status;
determining at least one lot which can be processed by the idle photolithography equipment according to equipment characteristics of the idle photolithography equipment; and
establishing the lot list according to the lots and a photo dispatching rule.

3. The method as claimed in claim 2, wherein the step of establishing the lot list according to the lots and the photo dispatching rule comprises:
providing a reticle management information, wherein the reticle management information comprises the mapping between the photolithography equipments and a plurality of reticles;
providing a measurement data corresponding to each of the lots, wherein the measurement data is generated in a previous photolithography operation performed to the lots;
determining whether each of the lots is the processable lot according to the photo dispatching rule, the reticle management information, and the corresponding measurement data; and
sorting all the processable lots to establish the lot list.

4. The method as claimed in claim 2, wherein the photo dispatching rule comprises a layer of the lot which can be processed by the photolithography equipments.

5. The method as claimed in claim 1, wherein the process background information comprises at least a product title, a layer, a reticle used, an exposing equipment used, or a previous information of a non-photolithography process of the processable lot.

6. The method as claimed in claim 1, wherein the photolithography operation type comprises a batch run, and the step of processing the processable lot according to the photolithography operation type comprises:
combining at least one of the processable lots into a processing batch automatically;
performing a testing of the photolithography operation on a testing chip selected from the processing batch; and
performing the photolithography operation to the processing batch according to a generated measurement data if the testing result meets a design specification.

7. The method as claimed in claim 1, wherein the photolithography operation type comprises a photo feedback system (PFBS) run, and the step of processing the processable lot according to the photolithography operation type comprises:
performing the photolithography operation to the processable lot according to a measurement data generated in a previous photolithography operation.

8. The method as claimed in claim 1, wherein the photolithography operation type comprises a composition run, and the step of processing the processable lot according to the photolithography operation type comprises:
performing n times of a batch run to the processable lot to generate a measurement data, wherein n is a positive integer; and
converting to a PFBS run automatically and performing the photolithography operation according to the measurement data.

9. The method as claimed in claim 1, wherein after the step of processing the processable lot according to the photolithography operation type, the method further comprises:
recording a measurement data generated in the photolithography operation performed to the processable lot.

10. The method as claimed in claim 1, wherein the different process background information is respectively corresponding to a different classification rule, and the photolithography operation type of the processable lots having the same process background information is determined according to the classification rule corresponding to the process background information of the processable lots.

11. A system for auto-dispatching lots in a photolithography process, comprising:
a lot list establishing system, for establishing a lot list according to a working status of at least one photolithography equipment, wherein the lot list comprises at least one processable lot;
a type determination module, coupled to the lot list establishing system, for selecting one of the processable lots from the lot list and determining a corresponding photolithography operation type according to a process background information of the selected processable lot; and
a photolithography processing system, coupled to the type determination module, for performing a photolithography operation to the selected processable lot according to the photolithography operation type.

12. The system as claimed in claim 11, wherein the lot list establishing system further comprises:
an idle equipment detection system, for detecting the photolithography equipment with an idle status;
a lot selection system, coupled to the idle equipment detection system, for selecting at least one lot which can be processed by the idle photolithography equipment according to equipment characteristics of the idle photolithography equipment; and
a lot arrangement system, coupled to the lot selection system, for establishing the lot list according to the lots and a photo dispatching rule.

13. The system as claimed in claim 12, wherein the lot list establishing system further comprises:
a reticle management information database, coupled to the lot arrangement system, for recording the mapping between the photolithography equipments and a plurality of reticles; and
a measurement data database, coupled to the lot arrangement system, for recording a measurement data generated in a previous photolithography operation performed to the lots.

14. The system as claimed in claim 12, wherein the photolithography processing system further records a measurement data into the measurement data database after performing the photolithography operation to the processable lot.

15. The system as claimed in claim 12, wherein the lot arrangement system further determines whether each of the lots is the processable lot according to the photo dispatching rule, the mapping between the photolithography equipments and the reticles, and the measurement data, and the lot arrangement system sorts all the processable lots to establish the lot list.

16. The system as claimed in claim 12, wherein the photo dispatching rule comprises a layer of the lot which can be processed by each of the photolithography equipments.

17. The system as claimed in claim 11, wherein the process background information comprises at least a product title, a layer, a reticle used, an exposing equipment used, or a previous information of a non-photolithography process of the processable lot.

18. The system as claimed in claim 11, wherein the photolithography operation type comprises a batch run, and the photolithography processing system automatically combines at least one of the processable lots into a processing batch, selects a testing chip from the processing batch to be tested in the photolithography operation, and performs a photolithography operation to the processing batch according to a generated measurement data if the testing result meets a design specification.

19. The system as claimed in claim 11, wherein the photolithography operation type comprises a PFBS run, and the photolithography processing system performs a photolithography operation to the processable lot according to a measurement data generated in a previous photolithography operation.

20. The system as claimed in claim 11, wherein the photolithography operation type comprises a composition run, and the photolithography processing system performs n times of a batch run to the processable lot to generate a measurement data, wherein n is a positive integer, then converts to a PFBS run automatically, and performs the photolithography operation according to the measurement data.

21. The system as claimed in claim 11 further comprising:
a classification rule database, for recording a plurality of classification rules respectively corresponding to different process background information, wherein the type determination module determines the photolithography operation type of the processable lots having the same process background information according to the classification rule corresponding to the process background information of the processable lots.
